(19) United States
(12) Patent Application Publication
(10) Pub. No.: US 2024/0141075 A1
(43) Pub. Date: May 2, 2024

(54) METHOD FOR PRODUCING A MODIFIED CATIONIZED POLYSACCHARIDE, MODIFIED CATIONIZED POLYSACCHARIDE AND ITS USE

(71) Applicant: KEMIRA OYJ, Helsinki (FI)

(72) Inventors: Jaakko HILTUNEN, Espoo (FI); Jonni AHLGREN, Espoo (FI); Sanna LEHTO, Espoo (FI); Eija AHONEN, Espoo (FI)

(21) Appl. No.: 18/281,067

(22) PCT Filed: Mar. 18, 2022
(86) PCT No.: PCT/FI2022/050172

§ 371 Date: Sep. 8, 2023

(30) Foreign Application Priority Data
Mar. 18, 2021 (FI) 20215297

(51) Int. Cl. C08B 15/06

(52) U.S. Cl. CPC C08B 15/06

(57) ABSTRACT

The invention relates to a method for producing a modified cationized polysaccharide. The method comprises preparing a reaction slurry by mixing of a starting material comprising a polysaccharide, preferably cellulose, and an alkaline liquid medium comprising an organic liquid, allowing the polysaccharide to interact with the alkaline liquid medium in the reaction slurry at a pre-treatment temperature under a pre-determined reaction time, and adjusting the temperature of the reaction slurry to modification temperature, which is less than the boiling point of the alkaline liquid medium. A cationizing agent and an alkylation agent, which comprises an epoxy group, are added to the reaction slurry at the modification temperature, and the polysaccharide is allowed to react with the alkylation agent and the cationizing agent, preferably under inert atmosphere, and obtaining a modified cationized polysaccharide product in solution form. The invention relates also to the modified cationized polysaccharide and its use as flocculation agent.

### CROSS REFERENCES

This is a U.S. national application of international application 371 of PCT/FI2022/050172 filed on Mar. 18, 2022 and claiming priority to Finnish national application number FI20215297 filed on Mar. 18, 2021.

### FIELD OF INVENTION

The present invention relates to a method for producing a modified cationized polysaccharide and to a modified cationized cellulose produced with the method according to the preambles of enclosed independent claims. The invention further relates to the use of modified cationized cellulose.

### BACKGROUND OF INVENTION

Cationized celluloses provide an interesting alternative for the synthetic polyelectrolytes in industrial processes. For example, international patent application PCT/FI2020/050817 discloses a method for producing highly cationic cellulose. Furthermore, the disclosed method enables the production of cationic cellulose at high consistency, which makes the method well suitable for production in industrial scale.

Despite the promising results obtained with cationic celluloses in various processes, where they have been tested as alternatives for synthetic polyelectrolytes, some challenges still remain. For example, in industrial liquid-solid separation processes and dewatering applications, such as sludge dewatering, cationic celluloses have been tested as flocculants. However, it has been observed that the floc strength may not always meet the process requirements, especially at high shear or during centrifuging. Consequently, there is still a need to improve the performance of the cationic celluloses in various industrial processes.

### SUMMARY OF INVENTION

An object of this invention is to minimise or possibly even eliminate the disadvantages existing in the prior art.

An object of the present invention is to provide a simple and effective method for modifying cationized polysaccharide.

An another object of the present invention is a water-soluble cationized polysaccharide which provides improved operational properties in liquid-solid separation processes, especially an increase in floc strength and/or floc size.

These objects are achieved by the features disclosed in the independent claims. Some preferred embodiments of the present invention are presented in the dependent claims. The features recited in the dependent claims are mutually freely combinable unless otherwise explicitly stated.

The exemplary embodiments presented in this text and their advantages relate to all aspects of the present invention, to the method and to modified cationized polysaccharide as well as to its use, even though this is not always separately mentioned.

A typical method for producing a modified cationized polysaccharide, preferably modified cationized cellulose, comprises
preparing a reaction slurry by mixing of a starting material comprising a polysaccharide, preferably cellulose, and an alkaline liquid medium comprising an organic liquid,
allowing the polysaccharide to interact with the alkaline liquid medium in the reaction slurry at a pre-treatment temperature under a pre-determined reaction time,
adjusting the temperature of the reaction slurry to a modification temperature, which is less than the boiling point of the alkaline liquid medium,
adding a cationizing agent and an alkylation agent, which comprises an epoxy group, to the reaction slurry at the modification temperature, and
allowing the polysaccharide to react with the alkylation agent and the cationizing agent, preferably under inert atmosphere, and obtaining a modified cationized polysaccharide product in solution form.

A typical modified cationized polysaccharide according to the present invention is obtainable by the method according to the present invention.

A typical use of the modified cationized polysaccharide is as a flocculating agent in a liquid-solid separation process, where
the flocculating agent is added to a process medium comprising solid material particles suspended in a continuous liquid phase,
the flocculating agent is allowed to form flocs with the solid material particles, and
the formed flocs are separated from the continuous liquid phase.

Now it has been surprisingly found that a modification of cationized polysaccharide, preferably cellulose, with an alkylation agent which comprises an epoxy group changes the properties of the obtained cationic polysaccharide in an unexpected manner. The modified cationized polysaccharide provides an improved floc size and/or floc strength in liquid-solid separation processes and dewatering applications. The modification of the structure of the cationized polysaccharide does not have any negative effect on the dewatering time. In general, the modified cationized polysaccharide is able to show properties which improve its suitability for industrial use.

### DETAILED DESCRIPTION OF THE INVENTION

In the present context the polysaccharide may be any suitable polysaccharide, such as cellulose, microfibrillated cellulose, starch, chitosan, guar gum, or the like, which can be modified and cationized in the process conditions of the present invention. Preferably the polysaccharide is cellulose or starch, more preferably cellulose. When polysaccharide is cellulose, the starting material may be selected from wood, wood-based materials or cellulose containing biomass. For example, the starting material may be selected from wood or wood-based materials, which originate from hardwood or softwood or their mixtures. According to one embodiment the starting material may be cellulosic pulp, such as dissolving pulp or Kraft pulp. One advantageous example of starting material is softwood Kraft pulp. According to another embodiment the starting material may be or originate from cellulose containing biomass, such as cotton, or from cellulose containing plant residues from agriculture and/or harvesting, such as cellulose containing material from sugar beet processing or the like. According to one embodiment the starting material may be or comprise microfibrillated cellulose or nanocellulose.

Preferably the starting material contains low amount of lignin, i.e. the starting material may be starch, chemical pulp or dissolving pulp, or it may originate from non-wood cellulose containing biomass. Preferably the cellulosic starting material may contain <50 weight-%, preferably <20 weight-%, more preferably <15 weight-%, even more preferably <10 weight-%, of lignin, and/or <30 weight-%, preferably <25 weight-%, even more preferably <10 weight-%, of hemicelluloses, calculated from the dry weight of the cellulosic starting material. For example, the cellulosic starting material may contain lignin in amount of 0-50 weight-%, preferably 0.01-20 weight-%, more preferably 0.1-15 weight-% or 0.1-10 weight-%, and/or hemicelluloses in amount of 0-30 weight-%, preferably 0.5-25 weight-%, more preferably 1-10 weight-%, all calculated from the dry weight of the cellulosic starting material. According to one embodiment, mechanical wood pulps are excluded from the possible starting materials.

In the present invention the cationization and modification of the polysaccharide is performed simultaneously, which makes the method simple and effective. It has been observed that due to the abundance of hydroxyl groups in the polysaccharide chain the cationization and epoxy-modification may be performed at the same time, even if both reactions take place at the hydroxyl groups of the polysaccharide. It was unexpectedly found that simultaneous cationization and modification reactions do not disturb each other.

The aqueous reaction slurry is prepared or obtained by mixing of a starting material comprising a polysaccharide, preferably cellulose, and an alkaline liquid medium comprising an organic liquid. Alkaline liquid medium denotes in the present context aqueous liquid phase, which comprises at least one alkaline agent, at least one organic liquid and water. The at least one alkaline agent may be selected from a group consisting of alkali hydroxides, such as NaOH, LiOH or KOH; carbonates, such as Na₂CO₃ or K₂CO₃; ammonium hydroxide, quaternary ammonium hydroxides and tetramethyl guanidine. Preferably the alkaline agent is selected from alkali hydroxides, more preferably alkaline agent comprises or is sodium hydroxide. The typical pH of the aqueous reaction slurry is high, for example, the pH of the slurry may be >12, for example pH 12-14. The amount of alkaline agent, such as NaOH, may be in a range of 7-18 weight-%, for example 7.5-15 weight-%, calculated from the total weight of the aqueous reaction slurry.

The alkaline liquid medium further comprises at least one organic liquid, which may be water-miscible or non-water-miscible, preferably water-miscible. The at least one organic liquid is preferably selected from a group consisting of secondary or tertiary alcohols, such as isopropanol, tert-butanol, sec-butanol, or any of their mixtures. According to one preferable embodiment the organic liquid comprises isopropanol or consists of or is isopropanol. It has been observed that when the alkaline medium comprises at least one organic liquid the produced cationized polysaccharide has a high degree of substitution, i.e. high charge density. The amount of organic liquid may be in a range of 30-55 weight-%, preferably 35-50 weight-%, more preferably 40-45 weight-%, calculated from the total weight of the slurry.

The aqueous reaction slurry may comprise organic liquid(s) and water in a ratio, which is from 1:1 to 3.5:1, preferably from 1.4:1 to 3.1:1, given as organic liquid(s):water. It is advantageous to keep the amount of water in the process as low as possible. It has been observed that the low water amount in the alkaline liquid medium provides optimal results in view of molecule size of the produced modified cationized polysaccharide.

The aqueous reaction slurry may comprise 20-40 weight-%, preferably 20-35 weight-%, more preferably 25-30 weight-%, of the starting material, calculated as dry, from the total weight of the slurry.

The polysaccharide, preferably cellulose, is allowed to interact with the alkaline liquid medium in the aqueous reaction slurry at a pre-treatment temperature under a pre-determined reaction time, preferably under constant mixing. This step functions as a pre-treatment step, where the starting material, preferably cellulosic starting material, is activated for the following cationization step. The pre-treatment step may be carried out under constant mixing of the aqueous reaction slurry comprising the starting material and the alkaline liquid medium in a suitable reactor, such as Lödige reactor or any other mixing reactor, which is suitable for mixing highly viscous systems. The pre-determined time for the pre-treatment may be from 10 minutes to 30 hours, preferably from 30 minutes to 20 hours, more preferably from 2 to 10 hours. The pre-treatment temperature may be ≤50° C., preferably ≤40° C., more preferably ≤35° C. The pre-treatment temperature may be ≤20° C. or <20° C., preferably ≤10° C., more preferably ≤5° C. For example, the pre-treatment temperature may be from −15° C. to +20° C., preferably from −10° C. to +10° C., more preferably from −5° C. to +5° C. The low pre-treatment temperature improves and/or enhances the dissolving and swelling of the polysaccharide present in the reaction slurry, and makes it more available for cationization and/or modification reactions.

After the pre-treatment step a cationizing agent and an alkylation agent comprising an epoxy group are added to the aqueous reaction slurry at a suitable reaction temperature for the cationization and modification, here denoted as the modification temperature. The cationizing agent and the alkylation agent can be added to the aqueous reaction slurry simultaneously but separately, or successively. The alkylation agent can be added to the reaction slurry immediately before or after the addition of the cationizing agent, preferably immediately before the cationizing agent.

The modification temperature is less than the boiling point of the alkaline liquid medium, which is present in the aqueous reaction slurry. Typically the modification temperature may be <100° C., for example in a range of 20-95° C., preferably 35-80° C., more preferably 40-60° C. or 40-55° C. The modification temperature is typically at least the same, preferably higher, than the pre-treatment temperature.

The polysaccharide, such as cellulose, is allowed to react with the alkylation agent and the cationizing agent. The cationization and modification reactions are preferably performed under an inert atmosphere, e.g. under nitrogen or argon, i.e. the reaction slurry is kept under inert atmosphere at least after the addition of the cationizing and alkylation agents. The reaction time for the cationization and modification be from 0.5 to 30 hours, preferably from 1 to 20 hours.

The alkylation agent comprising an epoxy group reacts with the hydroxyl groups present in the polysaccharide, preferably cellulose, structure. Thus the alkylation agent becomes an integral part of the polysaccharide structure and changes significantly the properties and/or behaviour of the polysaccharide.

According to one embodiment the alkylation agent may be selected from one or more alkyl glycidyl ethers, where the alkyl chain has in total at least four carbon atoms, preferably at least 6 carbon atoms, more preferably at least 8 carbon atoms or at least 10 carbon atoms. The alkyl chain may have in total at most 10 carbon atoms or sometimes at most 8 carbon atoms. The alkyl chain length of the alkyl glycidyl ether is selected to provide appropriate hydrophobicity. The alkyl glycidyl ether may be, for example, ethyl glycidyl ether, dodecyl glycidyl ether, tetradecyl glycidyl ether. According to one preferable embodiment the alkylation agent is ethyl glycidyl ether. The alkylation agent may further be selected from one or more uncharged alkyl epoxides, where the alkyl chain in total has at least two carbon atoms, preferably at least 4 carbon atoms, more preferably at least 6 carbon atoms, even more preferably at least 8 carbon atoms or at least 10 carbon atoms. The alkyl epoxide may be, for example, such as 1,2-butylene oxide, epoxy pentane, 1,2-epoxyoctane. It is also possible that the alkylation agent is selected from one or more epoxidized fatty acids and epoxidized fatty acid salts, which preferably comprise only one epoxide group, for example 9,10-epoxy stearic acid. The alkylation agent is free of aryl groups.

The alkylation agent may be added to the aqueous reaction slurry in an amount which is 1-50 weight-%, preferably 10-40 weight-%, more preferably 12-35 weight-%, of the weight of the polysaccharide in the starting material. In this manner a proper modification of the polysaccharide structure can be obtained, which provides improved properties in industrial applications, especially in liquid-solid separation.

The cationization agent may be selected from (3-chloro-2-hydroxypropyl)-trimethylammonium chloride (CHPTAC), glycidyltrimethylammonium chloride (GTAC) or any mixtures thereof. Preferably the cationization agent is CHPTAC or a mixture of CHPTAC and GTAC, more preferably CHPTAC. It is assumed, without wishing to be bound by a theory, that during the cationization reaction CHPTAC is converted to GTAC by a reaction with the hydroxyl ions present in the alkaline liquid medium.

The reaction slurry may comprise cationizing agent in an amount which is 7.5-35 weight-%, preferably 10-30 weight-%, more preferably 15-20 weight-%, calculated from the total weight of the reaction slurry. All chemical amounts are given as active agent.

Depending on the starting material and other process parameters, it is possible to use a mixture of various cationizing agents and/or alkylation agents at varying dosage ratios. For example, if the starting material is in form of cellulosic fibres, then CHPTAC as the cationizing agent may be preferable. If the starting material is in form of cellulosic nanofibers or microfibrillar cellulose for producing corresponding cationized products, then cationizing agent may be comprised at least partly, in some cases solely, of GTAC. Use of GTAC as the cationizing agent, either alone or together with CHPTAC is advantageous when a modified cationized cellulose with high charge density, for example >3 meq/g, is desired.

According to one preferable embodiment the cationizing agent is (3-chloro-2-hydroxypropyl)trimethylammonium chloride (CHPTAC), the modification agent is ethyl glycidyl ether, and the modification agent is added to the reaction slurry before the cationizing agent.

According to one embodiment of the present invention the aqueous reaction slurry may comprise one or more surface active agents for improving the dispersion or solubility of the reaction slurry components, especially alkylation agent into the aqueous reaction slurry.

The method according to the present invention provides a modified cationized polysaccharide, preferably modified cationized cellulose, in viscous liquid form. The obtained modified cationized polysaccharide is at least partly soluble in water, preferably fully soluble in water. The water-solubility can be observed as increased viscosity of the solution comprising the modified cationized polysaccharide, especially at higher concentrations. According to one preferable embodiment the viscosity of the modified cationized polysaccharide, preferably cellulose, may be at least 100 mPas, preferably at least 150 mPas, measured at 1.8 weight-% concentration of cationized cellulose in aqueous solution, comprising 9.1 weight-% of NaCl, at 25° C. For example, the viscosity of the modified cationized polysaccharide, preferably cellulose may be in a range of 100-10 000 mPas, preferably 150-10 000 mPas. The viscosity values are measured by using Brookfield DV-II+ Pro viscometer with a small sample adapter, spindle #18, with maximum possible rotational speed.

The modified cationized polysaccharide, preferably cellulose, may have a charge density of at least 1.5 meq/g dry, preferably at least 1.75 meq/g dry, more preferably at least 2 meq/g dry, measured at pH 4. The charge density may be, for example, in a range of 1.5-4 meq/g dry, preferably 1.75-3.8 meq/g dry, more preferably 2-3.5 meq/g dry, measured at pH 4. The charge density can be determined in a conventional manner, e.g. by using AFG Analytics' particle charge titrator.

According to one embodiment of the invention the obtained modified cationized polysaccharide, preferably cellulose, comprises
substituent groups originating from the alkylation agent, wherein a number of the substituent group per an anhydroglucose unit of the polysaccharide is at least 0.1, preferably at least 0.2, and preferably less than 0.8, more preferably less than 0.7 or 0.5; and/or
cationic groups originating from the cationization agent, wherein a number of the cationic groups per an anhydroglucose unit of the polysaccharide, i.e. degree of cationic group substitution, is at least 0.3, preferably at least 0.4, more preferably at least 0.5, sometimes even more than 1. According to one embodiment the degree of cationic group substitution may be in a range of 0.3-2.3, preferably 0.4-2, more preferably 0.4-1.6 or 1.05-1.6. According to one preferable embodiment the degree of cationic group substitution may be in a range of 0.4-0.7, providing for example good performance in liquid-solid separation processes.

The modified cationized polysaccharide, preferably cellulose, may be purified in different ways, for example by washing, precipitation and/or filtration. For example, the modified cationic polysaccharide, preferably cellulose, may be precipitated by using an organic liquid, which is the same or different from the organic liquid included in the alkaline liquid medium, whereafter the precipitated modified cationized polysaccharide, preferably cellulose, may be washed with a washing liquid. The organic liquid may be removed by evaporating or decanting. Alternatively, or in addition, the obtained modified cationized polysaccharide, preferably cellulose (in solution form) may be purified from various residues by using a membrane filtration. Before any purification, the modified cationized polysaccharide, preferably cellulose, may be neutralized.

The obtained modified cationized polysaccharide, preferably cellulose, preferably after the purification step, may be dried and ground to a particulate form or dry powder. The dried and ground modified cationized polysaccharide, preferably cellulose may be sieved for separating the different particle size fraction.

The modified cationized polysaccharide is suitable as a flocculating agent in a liquid-solid separation process, where the flocculating agent is added to a process medium comprising solid material particles suspended in a continuous liquid phase, the flocculating agent is allowed to form flocs with the solid material particles, and the formed flocs are separated from the continuous liquid phase. The modified cationized polysaccharide, preferably cellulose, according to the present invention is especially suitable for use as a flocculating agent in industrial liquid-solid separation processes, such as treatment of municipal or industrial wastewater. It has been observed that the modified cationized polysaccharide is able to provide larger and/or stronger flocs, which improves the efficiency of the sludge formation and/or dewatering in these processes.

According to one embodiment, the modified cationized polysaccharide is suitable as a flocculating agent in a sludge dewatering step of a water treatment process, for example, of municipal wastewater treatment process or industrial wastewater treatment process. The sludge to be dewatered may be municipal wastewater sludge or agricultural sludge, or it may originate from a biological treatment process of wastewater and/or sewage. Alternatively, the sludge may originate from an industrial process, especially from wastewater treatment of an industrial process, or from food or beverage production or from food or beverage processing.

The sludge, i.e. suspension, to be flocculated with the modified cationized cellulose may comprise a continuous aqueous liquid phase and organic and/or inorganic solid material and/or particles suspended in the aqueous liquid phase. The sludge may be rich in material of bacterial origin, especially if it originates from a water treatment process. The aqueous liquid phase of the sludge may contain also dissolved organic substances, such as polysaccharides, humic substances and fatty acids. The suspension may have a biological oxygen demand (BOD)>50 mg/l, chemical oxygen demand (COD) in a range of 15-45 g/l, preferably 20-40 g/l, and/or a dry solids content in a range of 5-80 g/l, preferably 10-60 g/l, more preferably 20-55 g/l. pH of the sludge may be in a range from pH 6 to pH 9, preferably from pH 7 to pH 8. The conductivity of the sludge may be in a range of 5-14 mS/cm, preferably 5-10 mS/cm, and/or the charge density may be in a range from −5.5 to −1.5 μeq/g, preferably from −5.0 to −1.8 μeq/g. Total phosphorous value for the sludge may be in a range of 400-1400 mg/l, preferably 450-1200 mg/l and/or the total nitrogen value in a range of 1.2-3.5 g/l, preferably 1.5-3.0 g/l.

If the present invention is used for providing flocculation in any liquid-solid separation process, which is wastewater treatment process, especially sludge dewatering step, the modified cationized cellulose may be brought into a contact with the sludge in amount of 1-30 kg/ton dry sludge, preferably 2-20 kg/ton dry sludge, more preferably 3-15 kg/ton dry sludge.

According to one preferred embodiment of the present invention the modified cationized polysaccharide, preferably cellulose, is subjected to high-shear homogenization before its addition to the process medium comprising solid material particles suspended in the liquid phase. The modified cationized polysaccharide, as solution, may be subjected to shear force in any suitable high-shear apparatus or high-shear device, which is able to create shear forces in aqueous systems. For example, the modified cationized polysaccharide may be subjected to shear force in a homogenizer, a high-speed mixer, a disperser, a rotor-stator mixer, a mixer with two counterrotating rotors, centrifugal pumping device providing a straight flow or back rotation flow, high pressure devices or the like. In some cases also ultrasonic treatment is applicable. Suitable high-shear mixing apparatuses and homogenizers are well-known for a person skilled in the art and commercially available, for example under tradenames Ultra Turrax®, Polytron®, Atrex®, Silverson® and Ystral®. For example, the modified cationized polysaccharide is dissolved or dispersed in water, subjected to high-shear homogenisation and added to the process medium comprising solid material particles. It was unexpectedly found that the high-shear homogenization, for example by using high-shear homogenizers such as Ultra Turrax® homogenizer, significantly improves the performance of the modified cationized polysaccharide as flocculating agent in liquid-solid separation, as well as the floc strength. The background of the phenomenon is not yet fully understood, but it is speculated that, without wishing to be bound by any theory, the high-shear homogenization may open the structure of the modified cationized polysaccharide, especially cellulose, and thus enable a more effective interaction between its functional groups and the solid material particles. The high-shear homogenisation may be achieved by using rotational speed of at least 2000 rpm. The high-shear homogenization may be achieved also by a process step where the modified cationized polysaccharide is subjected to high shear by centrifugal pumps or the like, e.g. during pumping of the modified cationized polysaccharide after it has been dissolved or dispersed in water.

### EXPERIMENTAL

### Example 1: Preparation of Modified Cationized Polysaccharide (BBFCE-R46)

High-molecular weight dissolving pulp, refined to 30° SR, was used as raw material. The pulp was pre-dried to dry content of 90.9 weight-% in a 6 litre Lödige DVT 5 reactor, equipped with mechanical mixers and temperature control jacket. The temperature in the jacket was set to 105° C. using a thermostat bath circulating the warming/cooling medium liquid.

Sodium hydroxide solution and isopropanol (IPA) were cooled down in fridge at least overnight. 346 g of pre-dried dissolving pulp at dry content 90.8 weight-% (314 g as dry cellulose) was added into the Lödige reactor. The temperature of the reactor jacket was set to 0° C. 275 g of 30.1 weight-% sodium hydroxide solution and 459 g of isopropanol were mixed together before adding into the reactor. The reaction slurry was mixed 22 h, 100 rpm, temperature 0° C.

Solution of (3-chloro-2-hydroxypropyl)trimethylammonium chloride solution (CHPTAC, Sigma-Aldrich, 60 weight-% active) was cooled down in a fridge. 512 g of CHPTAC was weighed to a beaker and pumped at 1 l/h speed into the Lödige reactor containing an intermediate product from the preceding reaction with sodium hydroxide and isopropanol. During the CHPTAC feed the mixing was continued and the temperature in the reactor jacket was maintained at 10° C. After all CHPTAC was fed into the reactor 100 g of mixture of dodecyl glycidyl ether and tetradecyl glycidyl ether (Sigma-Aldrich, technical grade, CAS 68609-97-2) was subsequently fed into the reactor. At the end of feeding, the temperature of the reactor jacket was increased to 60° C. After all chemicals had been fed in, an additional dosage of 150 g isopropanol was pumped through the same tube at same speed to flush all chemical residues into the reactor. After all solutions were in the reactor and temperature of the bath had reached 60° C., the lid of the reactor was closed and nitrogen flow to reactor was started at 1 l/min. Calculation of the reaction time was started at this point. The reaction was continued 23 hours.

When the reaction was finished, a part of the reaction mass was taken from the reactor for purification. The taken part of the reaction mass was dissolved in water in ratio 1:8 (reaction mass to water) and mixed with a magnetic stirrer for 15 min. After this the pH of the solution was decreased to pH 4.3-6.5 by using 50 weight-% acetic acid. Then the solution was poured to isopropanol (IPA) in ratio of 1 g dissolved reaction mass to 50 ml IPA. The solution was filtered using black ribbon filter paper. The filtered cake was washed three times. In two first washing times washing liquid IPA/water 70/30 (by volume) was used. The last washing was made by using washing liquid IPA/water 80/20 (by volume). Washing was done by dispersing the filtered cake in the washing liquid in ratio ‘filtered cake to washing liquid’ of 1:10 for 15 min. The mixture was filtered using black ribbon filter paper. The last filtered cake was dried overnight at 60° C.

The obtained modified cationized cellulose was characterized as follows: Charge density at pH 4 was determined using AFG Analytics' particle charge titrator. Cationized cellulose sample was dissolved as 0.025-0.05 weight-% solution in deionized water, pH was adjusted to 4.0 with 0.1 M acetic acid and titrated using 0.001 N sodium polyethylenesulfonate (PES-Na) solution as the titrant. During titration pH was normally increasing 0.1-0.2 pH units. The modified cationized cellulose BBFCE-R46 had charge density 1.72 meq/g dry sample.

Viscosity of cationized cellulose solution in water in presence of salt was determined using a Brookfield DV-II+ Pro viscometer with a small sample adapter at 25° C., using spindle #18. The viscosity measurement is performed by using maximum possible rotational speed. Cellulose sample was first dissolved in deionized water as 2 weight-% solution. Then sodium chloride (NaCl) in weight ratio NaCl:cellulose of 5:1 was added and let to dissolve under mixing before viscosity was measured. This means that the viscosity of the cationized cellulose is measured at 1.8 weight-% concentration of cationized cellulose in an aqueous solution comprising 9.1 weight-% of NaCl. The modified cationized cellulose BBFCE-R46 had viscosity 976 mPas, measured in presence of NaCl, at 3 rpm.

Conductivity of 0.5 weight-% cellulose solution in deionized water was measured using Knick SE 204 sensor. The modified cationized cellulose BBFCE-R46 had conductivity 0.58 mS/cm.

Turbidity of 1 weight-% cationized cellulose solution in deionized water was measured using HACH, 2100 AN IS Laboratory Turbidimeter. The modified cationized cellulose BBFCE-R46 had turbidity 449 NTU.

### Example 2: Preparation of Non-Modified Cationized Cellulose (BBFCE-R44) for Comparative Tests

High-molecular weight dissolving pulp, refined to 30° SR, was used as raw material. The pulp was pre-dried to dry content of 90.6 weight-% in a 6 litre Lödige DVT 5 reactor, equipped with mechanical mixers and temperature control jacket. The temperature in the jacket was set to 105° C. using a thermostat bath circulating the warming/cooling medium liquid.

Sodium hydroxide solution and isopropanol (IPA) were cooled down in fridge at least overnight. 347 g of pre-dried dissolving pulp at dry content 90.6 weight-% (314 g as dry cellulose) was added into the Lödige reactor. The temperature of the reactor jacket was set to 0° C. 275 g of 40 weight-% sodium hydroxide solution and 376 g of isopropanol were mixed together before adding into the reactor. The reaction slurry was mixed 21.3 h, 100 rpm, temperature 0° C.

Solution of (3-chloro-2-hydroxypropyl)trimethylammonium chloride solution (CHPTAC, Sigma-Aldrich, 60 weight-% active) was cooled down in a fridge. 512 g of CHPTAC was weighed to a beaker and pumped at 1 l/h speed into the reactor containing an intermediate product from the preceding reaction with sodium hydroxide. During the CHPTAC feed the mixing was continued and the temperature in the reactor jacket was maintained at 10° C. At the end of feeding of CHPTAC, the temperature of the reactor jacket was increased to 60° C. After all the CHPTAC had been fed in, an additional dosage of 100 g isopropanol was pumped through the same tube at same speed to flush all CHPTAC into the reactor. After all solutions were in the reactor and temperature of the bath had reached 60° C., the lid of the reactor was closed and nitrogen flow to reactor was started at 1 l/min. Calculation of the reaction time was started at this point. The reaction was continued 23 hours.

The sample was purified and characterized in similar manner as described in Example 1. Following values were measured for non-modified cationized cellulose BBFCE-R44:
charge density 1.76 meq/g dry sample;
viscosity 5729 mPas, measured in presence of NaCl, 0.3 rpm;
conductivity 0.51 mS/cm;
turbidity 381 NTU.

### Application Example 3: Determining the Floc Size by Focused Beam Reflectance Measurement (FBRM)

The FBRM instrument is a flocculation analyzer using a highly focused laser beam and back-scattered geometry as a principle of operation. From the collected data the FBRM instrument yields chord length distribution, mean of the chord length values and the number of particles detected. The measurement range of the device is 1-1000 μm. Used FBRM apparatus in this example is Lasentec FBRM Model D600L by Laser Sensor Technology, Redmond, WA, USA, Serial No. 1106, and its detector is D600L-HC22-K, Serial No. 961.

Mean of the chord length value is used as the value for floc size in examples.

Digested sludge for the floc size determination examples was collected from a waste water treatment plant (Suomenoja Espoo, Finland). Dry content of sludge was 2.9%, and for FBRM tests the sludge was diluted to 0.75% dry content. 500 ml of diluted sludge was used in the tests. Mixing was done using a motor mixer with speed 1000 rpm.

The cellulose samples from Examples 1 and 2 were used as 0.2% solutions. The cellulose samples were tested as such after dissolution. Modified cellulose sample from Example 1 was also subjected to high shearing treatment after dissolution but before floc size determination. When high shearing treatment was applied, it was done by mixing the freshly made cellulose solution using Ultra-Turrax IKA T 25 D homogenizer with blade S 25 N-25 F 3-5 min at 16000 rpm until the solution became slightly warmed. High shearing treated sample is indicated with “+UT”.

A high cationic starch without hydrophobic treatment is used as the reference. The high cationic starch had charge density 4.2 meq/g dry (at pH 4); Brookfield viscosity 47 mPas at 25° C., measured as 2.6% solution in water in presence of 13.0% NaCl, by using spindle #18, 60 rpm.

The diluted sludge was poured into a beaker, and mixing was started. The cellulose sample solution was dosed at time 0 s. Then mixing and data collection was continued for 120 s. In the results maximum floc size was seen at time interval of 0-10 s. Residual floc size was measured at time 60 s, i.e. after 1 min of mixing after the cellulose sample dosing.

The floc size results are shown in Table 1. It can be seen from the results shown in Table 1 that the modified cationized cellulose is able to provide similar floc size than the reference cellulose after mixing of 1 min. Furthermore, the difference between the maximum floc size and the floc size after 1 min mixing is much smaller for the modified cationized cellulose, which may indicate improved floc strength and/or floc shear resistance. It can be further seen that the high shearing treatment clearly improves the performance of the modified cationized cellulose.

TABLE 1
Floc size results for Application Example 3.

| | Dose | max. floc | floc size, after |
|---|---|---|---|
| Polymer sample | [kg/t] | size | 1 min mixing |
| high cationic starch | 6 | 42 | 21 |
| (reference) | 10 | 58 | 30 |
| | 14 | 67 | 32 |
| | 18 | 57 | 28 |
| BBFCE-R44 | 6 | 21 | 17 |
| | 10 | 30 | 21 |
| | 14 | 38 | 24 |
| | 18 | 49 | 30 |
| BBFCE-R46 + UT | 6 | 40 | 23 |
| | 10 | 74 | 42 |
| | 14 | 80 | 50 |
| | 18 | 80 | 52 |
| BBFCE-R46 | 6 | 21 | 16 |
| | 10 | 25 | 19 |
| | 14 | 34 | 22 |
| | 18 | 44 | 26 |

### Application Example 4: Sludge Dewatering Tests Using CST Method

The capillary suction time (CST) test was carried out using the Triton type 319 Multi-purpose CST (Triton Electronics Ltd, UK) with a type 317 Stirrer-Timer (Triton Electronics Ltd, UK). The digested sludge was the same as in application Example 3 but used without dilution.

The cellulose samples and their treatment were the same as in Example 3.

In the CST test the mixing speed was 1000 rpm. Cylinder used had diameter 18 mm. The cellulose sample was added to 100 g of the digested sludge, and mixed 10 s after dosing. After 10 s mixing a 4.5 ml sample was taken to the cylinder and the CST value was measured.

The CST results are shown in Table 2. It can be seen from Table 2 that the modified cationized cellulose sample also performs better in dewatering tests.

Table 2 CST results (s) for Application Example 4. A blank test result without any cellulose addition was 349 s, given as an average of 3 measurements.

| | high cationic | | | |
|---|---|---|---|---|
| Dose | starch | | | BBFCE-R46 + |
| [kg/t] | (Ref.) | BBFCE-R44 | BBFCE-R46 | UT |
| 4 | 57 | 60 | 103 | 30 |
| 8 | 13 | 42 | 63 | 12 |
| 10 | 11 | 31 | 20 | 11 |
| 14 | 13 | 15 | 20 | 11 |

It is apparent to a person skilled in the art that the invention is not limited exclusively to the examples and embodiments described above, but that the invention can vary within the scope of the claims presented below.

1. A method for producing a modified cationized polysaccharide, preferably modified cationized cellulose, the method comprising
preparing a reaction slurry by mixing of a starting material comprising a polysaccharide, preferably cellulose, and an alkaline liquid medium comprising an organic liquid,
allowing the polysaccharide to interact with the alkaline liquid medium in the reaction slurry at a pre-treatment temperature under a pre-determined reaction time,
adjusting the temperature of the reaction slurry to modification temperature, which is less than the boiling point of the alkaline liquid medium,
adding a cationizing agent and an alkylation agent, which comprises an epoxy group, to the reaction slurry at the modification temperature, and
allowing the polysaccharide to react with the alkylation agent and the cationizing agent, preferably under inert atmosphere, and obtaining a modified cationized polysaccharide product in solution form.

2. The method according to claim 1, wherein the polysaccharide is cellulose and the starting material is selected from wood, wood based materials or cellulose containing biomass.

3. The method according to claim 1, wherein the alkylation agent is selected from one or more alkyl glycidyl ethers, where the alkyl chain has in total at least 4 carbon atoms, preferably at least 6 carbon atoms, more preferably at least 8 carbon atoms, such as ethyl glycidyl ether, dodecyl glycidyl ether, tetradecyl glycidyl ether.

4. The method according to claim 1, wherein the alkylation agent is selected from one or more uncharged alkyl epoxides, where the alkyl chain in total has at least 4 carbon atoms, preferably at least 6 carbon atoms, more preferably at least 8 carbon atoms, such as 1,2-butylene oxide, epoxy pentane, 1,2-epoxyoctane.

5. The method according to claim 1, wherein the alkylation agent is selected from one or more epoxidized fatty acids and epoxidized fatty acid salts.

6. The method according to claim 1, wherein the cationization agent is selected from (3-chloro-2-hydroxypropyl)trimethyl-ammonium chloride, glycidyltrimethylammonium chloride or any mixtures thereof.

7. The method according to claim 1, wherein the alkylation agent is added to the reaction slurry in an amount which is 1-50 weight-%, preferably 10-40 weight-%, more preferably 12-35 weight-%, of the weight of the polysaccharide in the starting material.

8. The method according to claim 1, wherein the reaction slurry comprises organic liquid(s) and water in a ratio from 1:1 to 3.5:1, preferably from 1.4:1 to 3.1:1.

9. The method according to claim 1, wherein the organic liquid is selected from a group consisting of secondary or tertiary alcohols, such as isopropanol, tert-butanol, sec-butanol, or any of their mixtures.

10. The method according to claim 1, wherein the pre-treatment temperature is ≤35° C., preferably ≤20° C., more preferably ≤10° C.

11. The method according to claim 1, wherein the modification temperature is in a range of 20-95° C., preferably 35-80° C., more preferably 40-60° C.

12. A modified cationized polysaccharide, obtainable by a method according to claim 1.

13. The modified cationized polysaccharide according to claim 12, wherein the modified cationized polysaccharide has a charge density of at least 1.5 meq/g dry, more preferably at least 1.75 meq/g dry, even more preferably at least 2 meq/g dry, measured at pH 4.

14. The modified cationized polysaccharide according to claim 12, wherein the polysaccharide comprises
substituent groups originating from the alkylation agent, wherein a number of the substituent group per an anhydroglucose unit of the polysaccharide is at least 0.1, preferably at least 0.2, and/or
cationic groups originating from the cationization agent, wherein a number of the cationic groups per an anhydroglucose unit of the polysaccharide is at least 0.3, preferably at least 0.4, more preferably at least 0.5.

15. A method for flocculation in a liquid-solid separation process, comprising:
adding the modified cationized polysaccharide according to claim 12 as a flocculating agent to a process medium comprising solid material particles suspended in a continuous liquid phase,
allowing the flocculating agent to form flocs with the solid material particles, and
separating the formed flocs from the continuous liquid phase.

16. The method of claim 15, wherein the modified cationized polysaccharide is subjected to high-shear homogenization before its addition to the process medium.

17. The method of claim 15, wherein the process medium is a municipal wastewater or industrial wastewater.
